(19) United States
(12) Patent Application Publication
(10) Pub. No.: US 2019/0378170 A1
(43) Pub. Date: Dec. 12, 2019

(54) SERVICE DEVICE AND METHOD OF OPERATING SAME

(71) Applicant: SK Planet Co., Ltd., Seongnam-si (KR)

(72) Inventor: Ki Chon Kang, Seoul (KR)

(73) Assignee: SK Planet Co., Ltd.

(21) Appl. No.: 16/385,216

(22) Filed: Apr. 16, 2019

(30) Foreign Application Priority Data
Jun. 7, 2018 (KR) 10-2018-0065401

(51) Int. Cl. G06Q 30/02; B64C 39/02

(52) U.S. Cl. CPC G06Q 30/0266; G06Q 30/0246; B64C 2201/126; G06Q 30/0267; B64C 39/024; G06Q 30/0252

(57) ABSTRACT

A service device and a method of operating the same are provided. The present disclosure provides configuring a moving path of an advertisement provision device in consideration of an area with a high concentration of subscribers in which subscriber terminals are concentrated and providing an advertisement to the area with a high concentration of subscribers through the advertisement provision device moving along the configured moving path.

### CROSS-REFERENCE TO RELATED APPLICATIONS

This application claims priority to and the benefit of Korean Patent Application No. 10-2018-0065401, filed on Jun. 7, 2018, the entire contents of which are incorporated herein by reference.

### TECHNICAL FIELD

The present disclosure relates to a method of configuring a moving path of an advertisement provision device in consideration of an area with a high concentration of subscribers in which subscriber terminals are concentrated and providing an advertisement (coupon) to the area with a high concentration of subscribers through the advertisement provision device moving along the configured moving path.

### BACKGROUND

As the market of applications that are executed on mobile devices such as smart phones, tablet pads, and the like rapidly expands, an advertisement market related thereto is expanding at a high speed.

When an application corresponding to an advertisement medium is executed, a mobile device (hereinafter, referred to as a “subscriber terminal”) may receive an advertisement provided from an advertisement provision device and display the advertisement on an execution screen of the application.

According to the prior art, there is a location-based advertisement (coupon) provision scheme that identifies an area with a high concentration of subscribers and provides an advertisement to subscriber terminals located in the corresponding area with a high concentration of subscribers.

In the location-based advertisement provision scheme, the area with a high concentration of subscribers corresponds to a densely populated area, for example, downtown or a business district, and is characterized in that it is a fixed location.

However, since subscriber terminals actually receiving the advertisement have a mobile characteristic, the densely populated area may vary according to the time and the situation. Thus, the effectiveness of the providing advertisement is in doubt when the area with a high concentration of subscribers is determined as a fixed area and an advertisement is provided to the area.

Accordingly, the present disclosure proposes a new method of identifying an area with a high concentration of subscribers, which may vary depending on the time and the situation, and providing an advertisement to the identified area.

### SUMMARY

The present disclosure has been made in order to solve the above-mentioned problems in the prior art, and an aspect of the present disclosure is to provide a method of configuring a moving path of an advertisement provision device in consideration of an area with a high concentration of subscribers in which subscriber terminals are concentrated and providing an advertisement to the area with a high concentration of subscribers through the advertisement provision device moving along the configured moving path.

In accordance with an aspect of the present disclosure, a service device is provided. The service device includes: a processor configured to process calculations related to provision of an advertisement through an advertisement provision device; and a memory configured to store at least one command executed through the processor, wherein the at least one command includes: an identification command for identifying an area with a high concentration of subscribers in which a predetermined number or more of subscriber terminals is concentrated based on location information acquired from subscriber terminals; and a configuration command for configuring the area with a high concentration of subscribers as a moving path of the advertisement provision device, thereby allowing the advertisement provision device to provide an advertisement to subscriber terminals in the area with a high concentration of subscribers while the advertisement provision device moves along the moving path.

Specifically, the configuration command may include, when there is two or more areas with a high concentration of subscribers, configuring a stopover moving path to pass through each of the two or more areas with a high concentration of subscribers, thereby allowing the advertisement provision device to provide an advertisement to each of the two or more areas with a high concentration of subscribers while the advertisement provision device moves along the stopover moving path.

Specifically, when distances between the two or more areas with a high concentration of subscribers are shorter than a threshold distance, the configuration command may include determining the two or more areas with a high concentration of subscribers as an advertisement provision group and configuring a stopover moving path to pass through areas with a high concentration of subscribers within the advertisement provision group.

Specifically, the stopover moving path may include a movement priority for determining a movement order of the advertisement provision device for each of the two or more areas with a high concentration of subscribers based on a subscriber cluster type of each of the two or more areas with a high concentration of subscribers.

Specifically, the subscriber cluster type may include a fixed cluster area, in which there is a high proportion of subscriber terminals of which locations are changed within the threshold distance among all subscriber terminals within the area with a high concentration of subscribers, and a mobile cluster area, in which there is a high proportion of subscriber terminals of which locations are changed beyond the threshold distance among all subscriber terminals within the area with a high concentration of subscribers, and the mobile cluster area may have a higher movement priority than the fixed cluster area.

Specifically, the fixed cluster area may include a case in which there is a high proportion of subscriber terminals accessing a wireless relay device (AP) among all subscriber terminals within the area with a high concentration of subscribers, and the mobile cluster area may include a case in which there is a high proportion of subscriber terminals which do not access the wireless relay device (AP) among all subscriber terminals within the area with a high concentration of subscribers.

Specifically, the advertisement provision device may provide an advertisement according to at least one of a broadcasting scheme of broadcasting the advertisement to the area with a high concentration of subscribers and a wireless relay scheme of accessing the wireless relay device (AP) within the area with a high concentration of subscribers to transfer the advertisement to the subscriber terminal accessing the wireless relay device.

In accordance with another aspect of the present disclosure, a method of operating a service device is provided. The method includes: an identification step of identifying an area with a high concentration of subscribers in which a predetermined number or more of subscriber terminals is concentrated based on location information acquired from subscriber terminals; and a configuration step of configuring the area with a high concentration of subscribers as a moving path of the advertisement provision device, thereby allowing the advertisement provision device to provide an advertisement to subscriber terminals in the area with a high concentration of subscribers while the advertisement provision device moves along the moving path.

Specifically, the configuration step may include, when there is two or more areas with a high concentration of subscribers, configuring a stopover moving path to pass through each of the two or more areas with a high concentration of subscribers, thereby allowing the advertisement provision device to provide an advertisement to each of the two or more areas with a high concentration of subscribers while the advertisement provision device moves along the stopover moving path.

Specifically, the configuration step may include, when distances between the two or more areas with a high concentration of subscribers are shorter than a threshold distance, determining the two or more areas with a high concentration of subscribers as an advertisement provision group and configuring a stopover moving path to pass through areas with a high concentration of subscribers within the advertisement provision group.

Specifically, the stopover moving path may include a movement priority for determining a movement order of the advertisement provision device for each of the two or more areas with a high concentration of subscribers based on a subscriber cluster type of each of the two or more areas with a high concentration of subscribers.

Specifically, the subscriber cluster type may include a fixed cluster area, in which there is a high proportion of subscriber terminals of which locations are changed within the threshold distance among all subscriber terminals within the area with a high concentration of subscribers, and a mobile cluster area, in which there is a high proportion of subscriber terminals of which locations are changed beyond the threshold distance among all subscriber terminals within the area with a high concentration of subscribers, and the mobile cluster area may have a higher movement priority than the fixed cluster area.

According to a service device and a method of operating the same according to an embodiment of the present disclosure, it is possible to improve effectiveness of provision of an advertisement by configuring a moving path of an advertisement provision device in consideration of an area with a high concentration of subscribers in which subscriber terminals are concentrated and providing an advertisement to the area with a high concentration of subscribers through the advertisement provision device moving along the configured moving path so as to flexibly provide the advertisement suitable for the area with a high concentration of subscribers varying depending on the time and the situation.

### DRAWINGS

The above and other aspects, features and advantages of the present disclosure will be more apparent from the following detailed description taken in conjunction with the accompanying drawings, in which:

FIG. 1 is a schematic diagram of a location-based advertisement provision system according to an embodiment of the present disclosure;

FIG. 2 is a schematic configuration of an advertisement provision device according to an embodiment of the present disclosure;

FIG. 3 illustrates a hardware system for implementing an advertisement provision device according to an embodiment of the present disclosure;

FIG. 4 is a schematic configuration of a service device according to an embodiment of the present disclosure;

FIG. 5 illustrates a stopover moving path according to an embodiment of the present disclosure;

FIG. 6 illustrates a hardware system for implementing a service device according to an embodiment of the present disclosure;

FIG. 7 is a flowchart schematically illustrating an operation flow in a payment service system according to an embodiment of the present disclosure;

FIG. 8 is a flowchart schematically illustrating an operation flow in an advertisement provision device according to an embodiment of the present disclosure; and

FIG. 9 is a flowchart schematically illustrating an operation flow in a service device according to an embodiment of the present disclosure.

### DETAILED DESCRIPTION

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the spirit of the present disclosure should not be construed as being limited by the accompanying drawings. In addition to the accompanying drawings, the spirit of the present disclosure should be construed to cover all modifications, equivalents, and alternatives thereof.

Hereinafter, an embodiment of the present disclosure will be described with reference to the accompanying drawings.

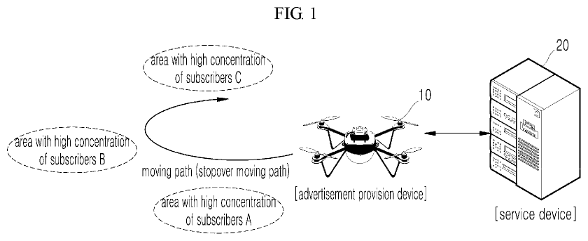

FIG. 1 illustrates a location-based advertisement provision system according to an embodiment of the present disclosure.

As illustrated in FIG. 1, a payment service system according to an embodiment of the present disclosure may include an advertisement provision device 10 configured to provide an advertisement and a service device 20 configured to configure a moving path of the advertisement provision device 10.

The advertisement provision device 10 refers to a device that moves along a moving path configured by the service device 20 and provides an advertisement to an area with a high concentration of subscribers corresponding to a destination or stops.

The advertisement provision device 10 may correspond to, for example, a drone (quadcopter), but it is not limited thereto, and may include any device that can communicate with the service device 20 and move along a configured moving path.

The service device 20 refers to a device that configures a moving path according to areas A, B, and C with a high concentration of subscribers identified based on location information of subscriber terminals (not shown) and provides a targeted advertisement (coupon) suitable for the configured moving path and the areas A, B, and C with a high concentration of subscribers to the advertisement provision device 10.

The subscriber terminals (not shown) are terminals in which an application for receiving a service provided from the service device 20 is installed, and may provide their own location information to the service device 20 based on the application.

The service device 20 may be implemented in the form of, for example, a web server, a database server, or a proxy server, or may be implemented as a computerized system through installation of one or more of various pieces of software that allow a network load distribution mechanism or the service device to operate over the Internet or another network. Further, the network may be an http network, a private line, an intranet, or another network, and a connection between elements within a payment service system according to an embodiment of the present disclosure may be made through a security network to prevent data from being compromised by an arbitrary hacker or another third party.

The payment service system according to an embodiment of the present disclosure may provide an advertisement to an area with a high concentration of subscribers in which subscriber terminals are concentrated based on the above-described configuration.

Meanwhile, as mentioned in the prior art in connection with this, in the conventional location-based advertisement provision method, the area with a high concentration of subscribers corresponds to a densely populated area, for example, downtown or a business district, and is characterized in that it is a fixed location.

However, subscriber terminals actually receiving the advertisement have a mobile characteristic, and particularly, the densely populated area may vary according to the time and the situation, so that the effectiveness of the provided advertisement is in doubt when a fixed area is specified as the area with a high concentration of subscribers and an advertisement is provided to the area, as in the prior art.

Accordingly, the present disclosure proposes a new method of flexibly specifying an area with a high concentration of subscribers, which may vary depending on the time or the situation, and providing an advertisement, and, hereinafter, elements of the advertisement device 10 and the service server 20 for implementing the new method will be described in more detail.

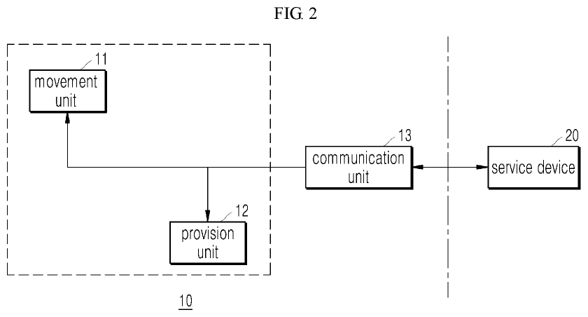

FIG. 2 illustrates the configuration of the advertisement provision device 10 according to an embodiment of the present disclosure.

As illustrated in FIG. 2, the advertisement provision device 10 according to an embodiment of the present disclosure may include a movement unit 11 configured to control movement of the advertisement provision device 10 and a provision unit 12 configured to provide an advertisement.

All or at least some of the elements of the advertisement provision device 10 including the movement unit 11 and the provision unit 12 may be implemented in the form of a software module or a hardware module executed by a processor or in the form of a combination of a software module and a hardware module.

Meanwhile, in addition to the above-described elements, the advertisement provision device 10 according to an embodiment of the present disclosure may further include a communication unit 13 configured to serve an actual RF function in order to communicate with the service server 20 and provide an advertisement.

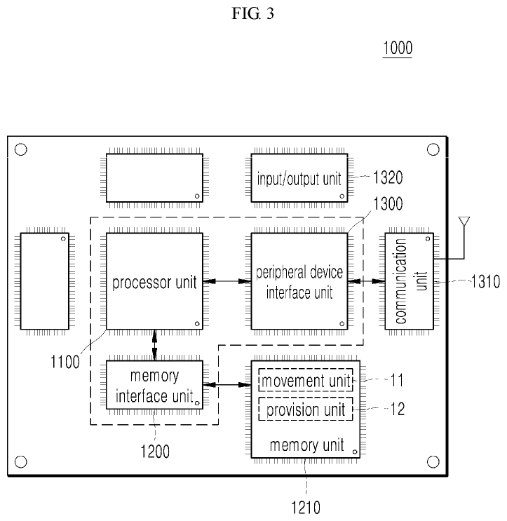

For reference, the configuration of the communication unit 13 is the configuration corresponding to a communication unit 1310 described with reference to FIG. 3, and a detailed description thereof will be made below.

As a result, the advertisement provision device 10 according to an embodiment of the present disclosure may provide an advertisement to an area with a high concentration of subscribers based on the above-described configuration, and, hereinafter, elements within the advertisement provision device 10 for implementing the same will be described in more detail.

The movement unit 11 performs a function of controlling the movement of the advertisement provision device 10.

More specifically, when a moving path is received from the service device 20, the movement unit 11 may control the movement of the advertisement provision device 10 according to the received moving path and thus place the advertisement provision device 10 in a destination or a stop on the configured moving path, in other words, in the area with a high concentration of subscribers.

In connection with this, the service device 20 identifies, as the area with a high concentration of subscribers, an area in which a predetermined number or more of subscriber terminals is concentrated based on location information acquired from subscriber terminals every configured cycle, configures a moving path having the identified area with a high concentration of subscribers as a destination or a stop, and provides the moving path to the advertisement provision device 10.

The advertisement provision device 10 receiving the moving path from the service device 20 may be understood as a device which is moving near the area with a high concentration of subscribers or is standing by.

Meanwhile, when two or more areas with a high concentration of subscribers are identified in connection with the configuration of the moving path, the service device 20 may configure a stopover moving path to pass through all of the two or more areas with a high concentration of subscribers.

That is, when the number of identified areas with a high concentration of subscribers is two or more, the service device 20 identifies distances between two or more areas with a high concentration of subscribers and, when the identified distances are shorter than a threshold distance, determines the two or more areas with a high concentration of subscribers as an advertisement provision group, so as to configure a stopover moving path to pass through all of the areas with a high concentration of subscribers within the advertisement provision group.

Of course, when the distances between the two or more areas with a high concentration of subscribers are all larger than a threshold distance, an individual moving path of each area with a high concentration of subscribers is configured.

Further, the stopover moving path may include a movement priority for determining a movement order based on a subscriber cluster type of each area with a high concentration of subscribers within the advertisement provision group.

The subscriber cluster type may include a fixed cluster area, having a high proportion of subscriber terminals, of which locations are changed within the threshold distance, among all subscriber terminals within the area with a high concentration of subscribers, and a mobile cluster area, having a high proportion of subscriber terminals, of which locations are changed beyond the threshold distance, among all subscriber terminals within the area with a high concentration of subscribers, wherein the mobile cluster area has a higher movement priority than the fixed cluster area.

As described above, the reason why the higher movement priority is assigned to the mobile cluster area than the fixed cluster area is to take into account the high probability that the cluster is scattered due to the mobile characteristic of subscriber terminals within the area with a high concentration of subscribers. Accordingly, by assigning the high priority to the mobile cluster area, an advertisement can be provided to the corresponding area with a high concentration of subscribers in less time.

Meanwhile, all areas with a high concentration of subscribers within the advertisement provision group may be mobile cluster areas, or conversely, may be fixed cluster areas, in which case the movement priority may be assigned in descending order of a proportion of subscriber terminals of which locations are changed within each area with a high concentration of subscribers.

In addition, the condition for determining the subscriber cluster type may be based on whether the subscriber terminal accesses a wireless relay device (AP), that is, a Wi-Fi network, as well as the change in the location of the subscriber terminal as described above.

In connection with this, the service device 20 may include the case in which a proportion of subscriber terminals accessing the wireless relay device (AP) is high among all subscriber terminals within the area with a high concentration of subscribers in the fixed cluster area or, conversely, the case in which a proportion of subscriber terminals accessing the wireless relay device (AP) is high among all subscriber terminals within the area with a high concentration of subscribers in the mobile cluster area.

The provision unit 12 performs a function of providing an advertisement.

More specifically, when it is identified that the advertisement provision device 10 is located in the area with a high concentration of subscribers configured as the destination or the stop, along which the moving path is configured, according to movement control, the provision unit 12 provides a location-based advertisement (coupon) to subscriber terminals located within the area with a high concentration of subscribers.

At this time, the provision unit 12 may provide the advertisement to the subscriber terminals within the area with a high concentration of subscribers through, for example, a broadcast scheme of broadcasting the advertisement to the area with a high concentration of subscribers or a wireless relay scheme of accessing the wireless relay device (AP) within the area with a high concentration of subscribers and transferring the advertisement to the subscriber terminals accessing the corresponding wireless relay device.

Meanwhile, it has been described that each element within the advertisement provision device 10 may be implemented in the form of a software module or a hardware module executed by the processor or in the form of a combination of a software module and a hardware module.

As described above, the software module and the hardware module executed by the processor, and the combination of the software module and the hardware module may be implemented by a hardware system (for example, a computer system).

Accordingly, hereinafter, a hardware system 1000 in which the advertisement provision device 10 according to an embodiment of the present disclosure is implemented in hardware form will be described with reference to FIG. 3.

For reference, the description below is an example of the hardware system 1000 in which each element within the above-described advertisement provision device 10 is implemented, and it should be noted that each element and the operation thereof may be different from those of an actual system.

As illustrated in FIG. 3, the hardware system 1000 according to an embodiment of the present disclosure may include a processor unit 1100, a memory interface unit 1200, and a peripheral device interface unit 1300.

The respective elements within the hardware system 1000 may be individual elements, or may be integrated into one or more integrated circuits, and may be combined by a bus system (not shown).

The bus system is an abstraction indicating one or more individual physical buses, communication lines/interfaces, multi-drop, and/or point-to-point connections connected by bridges, adaptors, and/or controllers as appropriate.

The processor unit 1100 may serve to execute various software modules stored in the memory unit 1210 by communicating with the memory unit 1210 through the memory interface unit 1200 in order to perform various functions in the hardware system.

The memory unit 1210 may store the movement unit 11 and the provision unit 12, which are elements within the advertisement provision device 10 described with reference to FIG. 2, in the form of a software module, and may further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 1210 includes a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 1300 serves to enable communication between the processor unit 1100 and peripheral devices.

The peripheral devices may provide different functions to the hardware system 1000 and may include, for example, a communication unit 1310 and an input/output unit 1320 according to an embodiment of the present disclosure.

The communication unit 1310 serves to provide a function of communication with another device. To this end, the communication unit 1310 may include, for example, an antenna system, an RF transceiver, one or more amplifiers, a tuner, one or more oscillators, a digital signal processor, a CODEC chipset, and a memory, but is not limited thereto, and may include a known circuit for performing the function.

Communication protocols supported by the communication unit 1310 may include, for example, Wireless LAN (WLAN), Digital Living Network Alliance (DLNA), Wireless broadband (WiBro), World interoperability for microwave access (WiMAX), Global System for Mobile communication (GSM), Code-Division Multiple Access (CDMA), Code-Division Multiple Access 2000 (CDMA2000), Enhanced Voice-Data Optimized or Enhanced Voice-Data Only (EV-DO), Wideband CDMA (WCDMA), High-Speed Downlink Packet Access (HSDPA), High-Speed Uplink Packet Access (HSUPA), IEEE 802.16, Long-Term Evolution (LTE), Long-Term Evolution-Advanced (LTE-A), Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultrasound Communication (USC), Visible Light Communication (VLC), Wi-Fi, and Wi-Fi Direct. Wired communication networks may include a wired Local Area Network (LAN), a wired Wide Area Network (WAN), Power-Line Communication (PLC), USB communication, Ethernet, serial communication, and optical fiber/coaxial cable, but are not limited thereto, and may include any protocol that can provide a communication environment with another device.

Further, the input/output unit 1320 may serve as a controller configured to control an I/O device linked to other hardware systems, and may control a driving system for processing actual movement of the advertisement provision device 10 in an embodiment of the present disclosure.

As a result, each element within the advertisement provision device 10 stored in the memory unit 1210 in the form of a software module in the hardware system 1000 according to an embodiment of the present disclosure may execute an interface with the communication unit 1310 and the input/output unit 1320 via the memory interface unit 1200 and the peripheral device interface unit 1300 in the form of instructions executed by the processor unit 1100, thereby providing the advertisement to the area with a high concentration of subscribers.

The description of the configuration of the advertisement provision device 10 according to an embodiment of the present disclosure has been completed, and the configuration of the service device 20 will be subsequently described.

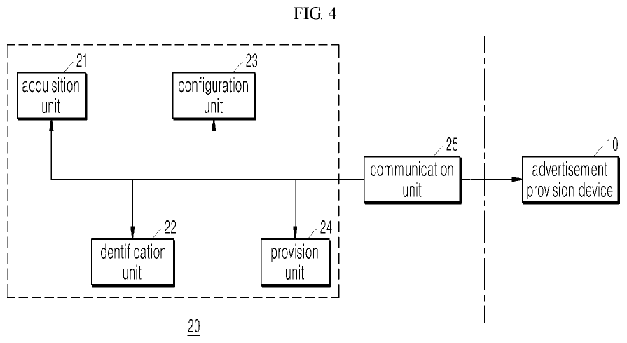

FIG. 4 illustrates a schematic configuration of the service device 20 according to an embodiment of the present disclosure.

As illustrated in FIG. 4, the service device 20 according to an embodiment of the present disclosure may include an identification unit 22 configured to identify an area with a high concentration of subscribers and a configuration unit 23 configured to configure a moving path.

Further, the service device 20 according to an embodiment of the present disclosure may further include an acquisition unit 21 configured to acquire location information of the subscriber terminal and a provision unit 24 configured to provide the moving path as well as the above-described elements.

All or at least some of the elements of the service device 20 including the acquisition unit 21, the identification unit 22, the configuration unit 23, and the provision unit 24 may be implemented in the form of a software module or a hardware module executed by the processor or in the form a combination of a software module and a hardware module.

The software module may be understood as, for example, instructions executed by the processor that controls calculations within the service device 20, and the instructions may have the form of being installed in a memory within the service device 20.

Meanwhile, the service device 20 according to an embodiment of the present disclosure may further include a communication unit 25, which is an RF module configured to support actual communication of the advertisement provision device 10, as well as the above-described elements.

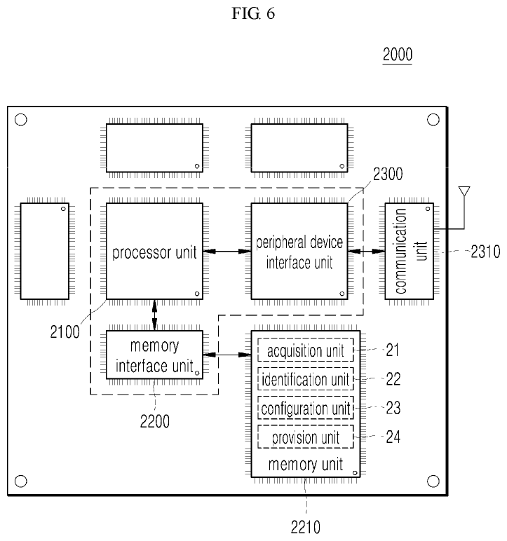

For reference, the configuration of the communication unit 25 is the configuration corresponding to a communication unit 2310 described with reference to FIG. 6, and thus a detailed description thereof will be made below.

As a result, the service device 20 according to an embodiment of the present disclosure may configure a moving path in consideration of an area with a high concentration of subscribers, identified based on location information of subscriber terminals, and allows the advertisement provision device 10 to provide an advertisement along the configured moving path, and, hereinafter, each element within the service device 20 for implementing the same will be described in more detail.

The acquisition unit 21 performs a function of acquiring location information from subscriber terminals.

More specifically, the acquisition unit 21 acquires location information through an application from subscriber terminals in which the corresponding application for receiving a service provided from the service device 20 is installed.

At this time, the acquisition unit 21 may acquire location information by receiving location information from the subscriber terminals every configured cycle or requesting and receiving location information from the subscriber terminals every configured cycle.

Meanwhile, when receiving the location information from the subscriber terminals, the acquisition unit 21 may also acquire information on whether the subscriber terminals access the wireless relay device (AP), that is, a Wi-Fi network.

The identification unit 22 performs a function of identifying an area with a high concentration of subscribers.

More specifically, the identification unit 22 identifies the area with a high concentration of subscribers based on the location information acquired from the subscriber terminals.

At this time, the area with a high concentration of subscribers may be understood as an area in which a predetermined number or more of subscriber terminals is concentrated, and the area with a high concentration of subscribers may be changed by locations of the subscriber terminals according to the time and the situation.

The configuration unit 23 performs a function of configuring a moving path.

More specifically, when the area with a high concentration of subscribers is identified based on the location information of the subscriber terminals, the configuration unit 23 configures a moving path in which the area with a high concentration of subscribers is a destination or a stop.

Meanwhile, when two or more areas with a high concentration of subscribers are identified based on the location information of the subscriber terminals, the configuration unit 23 configures a stopover moving path to pass through all of the two or more areas with a high concentration of subscribers, which will be described below in detail.

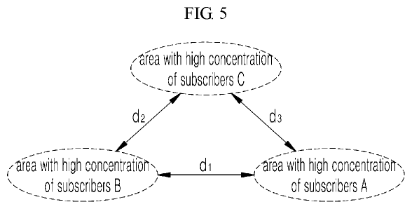

In connection with this, the case in which an area A with a high concentration of subscribers, an area B with a high concentration of subscribers, and an area C with a high concentration of subscribers are identified based on the location information of subscriber terminals is illustrated as an example in FIG. 5.

In this case, the configuration unit 23 identifies distances d₁, d₂, and d₃ between the area A with a high concentration of subscribers, the area B with a high concentration of subscribers, and the area C with a high concentration of subscribers, and when the identified distances d₁, d₂, and d₃ are shorter than a threshold distance, determines the area A with a high concentration of subscribers, the area B with a high concentration of subscribers, and the area C with a high concentration of subscribers as an advertisement provision group and configures a stopover movement path to pass through all of the areas with a high concentration of subscribers within the advertisement provision group.

When all of the distances between the area A with a high concentration of subscribers, the area B with a high concentration of subscribers, and the area C with a high concentration of subscribers are longer than the threshold distance, the configuration unit 23 configures individual movement paths of the area A with a high concentration of subscribers, the area B with a high concentration of subscribers, and the area C with a high concentration of subscribers.

The individual movement paths may be understood as different advertisement provision devices for providing an advertisement to the area A with a high concentration of subscribers, the area B with a high concentration of subscribers, and the area C with a high concentration of subscribers.

Meanwhile, the stopover movement path may include a movement priority for determining a movement order of each of the area A with a high concentration of subscribers, the area B with a high concentration of subscribers, and the area C with a high concentration of subscribers based on a subscriber cluster type of each of the area A with a high concentration of subscribers, the area B with a high concentration of subscribers, and the area C with a high concentration of subscribers.

The subscriber cluster type may include a fixed cluster area, having a high proportion of subscriber terminals, of which locations are changed within the threshold distance, among all subscriber terminals within the area with a high concentration of subscribers, and a mobile cluster area, having a high proportion of subscriber terminals, of which locations are changed beyond the threshold distance, among all subscriber terminals within the area with a high concentration of subscribers, wherein the mobile cluster area has a higher movement priority than the fixed cluster area.

As described above, the reason why the higher movement priority is assigned to the mobile cluster area than the fixed cluster area is to take into account the high probability that the cluster is scattered due to the mobile characteristic of subscriber terminals within the area with a high concentration of subscribers. Accordingly, by assigning the high priority to the mobile cluster area, an advertisement can be provided to the corresponding area with a high concentration of subscribers in less time.

Meanwhile, all of the area A with a high concentration of subscribers, the area B with a high concentration of subscribers, and the area C with a high concentration of subscribers may be mobile cluster areas, or conversely, may be fixed cluster areas, in which case the movement priority may be assigned in descending order of a proportion of subscriber terminals of which locations are changed within each area with a high concentration of subscribers.

In addition, the condition for determining the subscriber cluster type may be based on whether the subscriber terminal accesses a wireless relay device (AP), that is, a Wi-Fi network, as well as the change in the location of the subscriber terminal as described above.

In connection with this, the configuration unit 23 may include the case in which a proportion of subscriber terminals accessing the wireless relay device (AP) is high among all subscriber terminals within the area with a high concentration of subscribers in the fixed cluster area or, conversely, the case in which a proportion of subscriber terminals accessing the wireless relay device (AP) is high among all subscriber terminals within the area with a high concentration of subscribers in the mobile cluster area.

For reference, in connection with the configuration of the stopover movement path, when there is an area which does not meet the condition of the area with a high concentration of subscribers but in which some subscriber terminals are concentrated on the moving path between the areas with a high concentration of subscribers within the advertisement provision group, the configuration unit 23 may insert the area into the advertisement provision group as a stopover area and thus provide an advertisement to the stopover area during movement between the areas with a high concentration of subscribers.

The provision unit 24 performs a function of providing a moving path (stopover moving path).

More specifically, when a moving path in the case in which the number of areas with a high concentration of subscribers is one or a stopover moving path in the case in which the number of areas with a high concentration of subscribers is two or more is completely configured, the provision unit 24 provides the configured moving path (stopover moving path) to the advertisement provision device 10.

In connection with this, the advertisement provision device 10 places the advertisement provision device 10 in the destination or the stop configured as the moving path, that is, in the area with a high concentration of subscribers, by controlling the movement of the advertisement provision device 10 along the moving path received from the service device 20, and, when it is identified that the advertisement provision device 10 is located in the area with a high concentration of subscribers, provides a location-based advertisement (coupon) to subscriber terminals within the area with a high concentration of subscribers.

At this time, the advertisement provision device 10 may provide the advertisement to the subscriber terminals within the area with a high concentration of subscribers through, for example, a broadcast scheme of broadcasting the advertisement to the area with a high concentration of subscribers or a wireless relay scheme of accessing the wireless relay device (AP) within the area with a high concentration of subscribers and transferring the advertisement to the subscriber terminals accessing the corresponding wireless relay device.

Meanwhile, it has been described that each element within the service device 20 may be implemented in the form of a software module or a hardware module executed by the processor or a combination of the software module and the hardware module.

As described above, the software module and the hardware module executed by the processor, or the combination of the software module and the hardware module, may be implemented by a hardware system (for example, a computer system).

Accordingly, hereinafter, a hardware system 2000 in which the service device 20 according to an embodiment of the present disclosure is implemented in the hardware form will be described with reference to FIG. 6.

For reference, the following description is an example of the hardware system 2000 in which each element within the service device 20 is implemented, and it should be noted that each element and the operation thereof may be different from those of an actual system.

As illustrated in FIG. 6, the hardware system 2000 according to an embodiment of the present disclosure may include a processor unit 2100, a memory interface unit 2200, and a peripheral device interface unit 2300.

The respective elements within the hardware system 2000 may be individual elements, or may be integrated into one or more integrated circuits, and may be combined by a bus system (not shown).

The bus system is an abstraction indicating one or more individual physical buses, communication lines/interfaces, multi-drop, and/or point-to-point connections connected by bridges, adaptors, and/or controllers as appropriate.

The processor unit 2100 may serve to execute various software modules stored in the memory unit 2210 by communicating with the memory unit 2210 through the memory interface unit 2200 in order to perform various functions in the hardware system.

The memory unit 2210 may store the acquisition unit 21, the identification unit 22, the configuration unit 23, and the provision unit 24, which are the elements within the service device 20 described with reference to FIG. 4 in the form of a software module, and may further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 2210 includes a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 2300 serves to enable communication between the processor unit 2100 and peripheral devices.

The peripheral device may provide different functions to the hardware system 2000, and may include, for example, a communication unit 2310 according to an embodiment of the present disclosure.

The communication unit 2310 serves to provide a function of communication with another device. To this end, the communication unit 2310 may include, for example, an antenna system, an RF transceiver, one or more amplifiers, a tuner, one or more oscillators, a digital signal processor, a CODEC chipset, and a memory, but is not limited thereto, and may include any known circuit for performing the function.

Communication protocols supported by the communication unit 2310 may include, for example, Wireless LAN (WLAN), Digital Living Network Alliance (DLNA), Wireless broadband (WiBro), World interoperability for microwave access (WiMAX), Global System for Mobile communication (GSM), Code-Division Multiple Access (CDMA), Code-Division Multiple Access 2000 (CDMA2000), Enhanced Voice-Data Optimized or Enhanced Voice-Data Only (EV-DO), Wideband CDMA (WCDMA), High-Speed Downlink Packet Access (HSDPA), High-Speed Uplink Packet Access (HSUPA), IEEE 802.16, Long-Term Evolution (LTE), Long-Term Evolution-Advanced (LTE-A), Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultrasound Communication (USC), Visible Light Communication (VLC), Wi-Fi, and Wi-Fi Direct. Wired communication networks may include a wired Local Area Network (LAN), a wired Wide Area Network (WAN), Power Line Communication (PLC), USB communication, Ethernet, serial communication, and an optical fiber/coaxial cable, but are not limited thereto, and may include any protocol that can provide a communication environment with another device.

As a result, each element within the service device 20 stored in the memory unit 2210 in the form of a software module in the hardware system 2000 according to an embodiment of the present disclosure may execute an interface with the communication unit 2310 via the memory interface unit 2200 and the peripheral device interface unit 2300 in the form of instructions executed by the processor unit 2100, thereby supporting the configuration of a moving path in consideration of areas with a high concentration of subscribers identified based on location information of subscriber terminals and provision of the advertisement by the advertisement provision device 10 along the configured moving path.

As described above, according to the location-based advertisement provision system and each element within the system according to an embodiment of the present disclosure, it is possible to improve the effectiveness of provision of the advertisement by flexibly providing an advertisement suitable for an area with a high concentration of subscribers varying depending on the time and the situation because an area with a high concentration of subscribers in which subscriber terminals are concentrated is configured as a moving path of the advertisement provision device 10 and the advertisement is provided through the advertisement provision device moving along the configured moving path.

Hereinafter, the operation flow in the payment service system according to an embodiment of the present disclosure will be subsequently described.

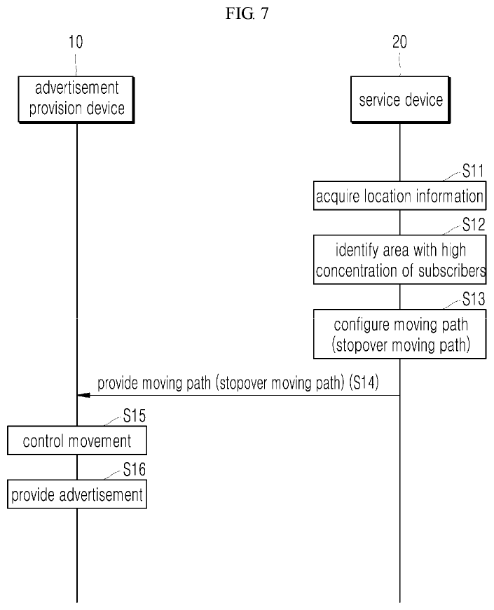

In connection with this, FIG. 7 illustrates the operation flow in the payment service system according to an embodiment of the present disclosure.

First, the service device 20 acquires location information through an application from the subscriber terminal in which the corresponding application is installed in S11.

At this time, the service device 20 may acquire location information by receiving location information from the subscriber terminal every configured cycle or requesting and receiving location information from the subscriber terminal every configured cycle.

Meanwhile, when receiving the location information from the subscriber terminal, the service device 20 may also acquire information on whether the subscriber terminal accesses the wireless relay device (AP), that is, a Wi-Fi network.

Then, the service device 20 identifies an area with a high concentration of subscribers based on the location information acquired from the subscriber terminal in S12.

At this time, the area with a high concentration of subscribers may be understood as an area in which a predetermined number or more of subscriber terminals is concentrated, and the area with a high concentration of subscribers may be changed by locations of the subscriber terminals according to the time and the situation.

Next, when the area with a high concentration of subscribers is identified based on the location information of the subscriber terminal, the service device 20 configures a moving path in which the area with a high concentration of subscribers is a destination or a stop in S13.

Meanwhile, in connection with configuration of the moving path, when two or more areas with a high concentration of subscribers are identified, the service device 20 may configure a stopover moving path to pass through all of the two or more areas with a high concentration of subscribers.

That is, when the number of identified areas with a high concentration of subscribers is two or more, the service device 20 identifies distances between two or more areas with a high concentration of subscribers and when the identified distance are shorter than a threshold distance, determines the two or more areas with a high concentration of subscribers as an advertisement provision group, so as to configure a stopover moving path to pass through all of the areas with a high concentration of subscribers within the advertisement provision group.

Of course, when the distances between the two or more areas with a high concentration of subscribers are all larger than a threshold distance, an individual moving path of each area with a high concentration of subscribers is configured.

Further, the stopover moving path may include a movement priority for determining a movement order based on a subscriber cluster type of each area with a high concentration of subscribers within the advertisement provision group.

The subscriber cluster type may include a fixed cluster area, having a high proportion of subscriber terminals, of which locations are changed within the threshold distance, among all subscriber terminals within the area with a high concentration of subscribers, and a mobile cluster area, having a high proportion of subscriber terminals, of which locations are changed beyond the threshold distance, among all subscriber terminals within the area with a high concentration of subscribers, wherein the mobile cluster area has a higher movement priority than the fixed cluster area.

As described above, the reason why the higher movement priority is assigned to the mobile cluster area than the fixed cluster area is to take into account the high probability that the cluster is scattered due to the mobile characteristic of subscriber terminals within the area with a high concentration of subscribers. Accordingly, by assigning the high priority to the mobile cluster area, an advertisement can be provided to the corresponding area with a high concentration of subscribers in less time.

Meanwhile, all areas with a high concentration of subscribers within the advertisement provision group may be mobile cluster areas, or conversely, may be fixed cluster areas, in which case the movement priority may be assigned in descending order of a proportion of subscriber terminals of which locations are changed within each area with a high concentration of subscribers.

In addition, the condition for determining the subscriber cluster type may be based on whether the subscriber terminal accesses a wireless relay device (AP), that is, a Wi-Fi network, as well as the change in the location of the subscriber terminal, as described above.

In connection with this, the service device 20 may include the case in which a proportion of subscriber terminals accessing the wireless relay device (AP) is high among all subscriber terminals within the area with a high concentration of subscribers may be included in the fixed cluster area or, conversely, the case in which a proportion of subscriber terminals accessing the wireless relay device (AP) is high among all subscriber terminals within the area with a high concentration of subscribers may be included in the mobile cluster area.

Next, when a moving path in the case in which the number of areas with a high concentration of subscribers is one or a moving path in the case in which the number of areas with a high concentration of subscribers is two or more is completely configured, the service device 20 provides the configured moving path (stopover moving path) to the advertisement provision device 10 in S14.

Further, when the moving path from the service device 20 is received, movement is controlled according to the received moving path, so that the advertisement provision device 10 is placed in the destination or the stop configured as the moving path, that is, the area with a high concentration of subscribers in S15.

Thereafter, when it is identified that the advertisement provision device 10 is located in the area with a high concentration of subscribers configured as the destination or the stop along the configured moving path according to the control of the movement, the advertisement provision device 10 provides a location-based advertisement (coupon) to subscriber terminals located within the area with a high concentration of subscribers.

At this time, the advertisement provision device 10 may provide the advertisement to the subscriber terminals within the area with a high concentration of subscribers through, for example, a broadcast scheme of broadcasting the advertisement to the area with a high concentration of subscribers or a wireless relay scheme of accessing the wireless relay device (AP) within the area with a high concentration of subscribers and transferring the advertisement to the subscriber terminals accessing the corresponding wireless relay device.

The description of the operation flow in the payment service system according to an embodiment of the present disclosure has been completed, and the operation flow in the advertisement provision device 10 will be subsequently described.

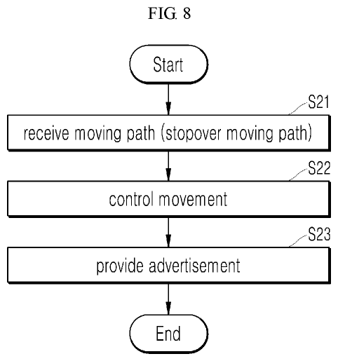

In connection with this, FIG. 8 illustrates the operation flow in the advertisement provision device 10 according to an embodiment of the present disclosure.

First, when the moving path is received from the service device 20, the movement unit 11 places the advertisement provision device 10 in the destination or the stop configured as the moving path, that is, in the area with a high concentration of subscribers, by controlling the movement of the advertisement provision device 10 according to the received moving path in S21 and S22.

In connection with this, the service device 20 identifies, as the area with a high concentration of subscribers, an area in which a predetermined number or more of subscriber terminals is concentrated based on location information acquired from subscriber terminals every configured cycle, configures a moving path having the identified area with a high concentration of subscribers as a destination or a stop, and provides the moving path to the advertisement provision device 10.

The advertisement provision device 10 receiving the moving path from the service device 20 may be understood as a device which is moving near the area with a high concentration of subscribers or is standing by.

Meanwhile, in connection with configuration of the moving path, when two or more areas with a high concentration of subscribers are identified, the service device 20 may configure a stopover moving path to pass through all of the two or more areas with a high concentration of subscribers.

That is, when the number of identified areas with a high concentration of subscribers is two or more, the service device 20 identifies a distance between two or more areas with a high concentration of subscribers and determines the two or more areas with a high concentration of subscribers as an advertisement provision group, so as to configure a stopover moving path to pass through all of the areas with a high concentration of subscribers within the advertisement provision group.

Of course, when the distances between the two or more areas with a high concentration of subscribers are all larger than a threshold distance, an individual moving path of each area with a high concentration of subscribers is configured.

Further, the stopover moving path may include a movement priority for determining a movement order based on a subscriber cluster type of each area with a high concentration of subscribers within the advertisement provision group.

The subscriber cluster type may include a fixed cluster area, having a high proportion of subscriber terminals, of which locations are changed within the threshold distance, among all subscriber terminals within the area with a high concentration of subscribers, and a mobile cluster area, having a high proportion of subscriber terminals, of which locations are changed beyond the threshold distance, among all subscriber terminals within the area with a high concentration of subscribers, wherein the mobile cluster area has a higher movement priority than the fixed cluster area.

As described above, the reason why the higher movement priority is assigned to the mobile cluster area than the fixed cluster area is to take into account the high probability that the cluster is scattered due to the mobile characteristic of subscriber terminals within the area with a high concentration of subscribers. Accordingly, by assigning a high priority to the mobile cluster area, an advertisement can be provided to the corresponding area with a high concentration of subscribers in less time.

Meanwhile, all areas with a high concentration of subscribers within the advertisement provision group may be mobile cluster areas, or conversely may be fixed cluster areas, in which case the movement priority may be assigned in descending order of a proportion of subscriber terminals of which locations are changed within each area with a high concentration of subscribers.

In addition, the condition for determining the subscriber cluster type may be based on whether the subscriber terminal accesses a wireless relay device (AP), that is, a Wi-Fi network, as well as the change in the location of the subscriber terminal as described above.

In connection with this, the service device 20 may include the case in which a proportion of subscriber terminals accessing the wireless relay device (AP) is high among all subscriber terminals within the area with a high concentration of subscribers may be included in the fixed cluster area, or conversely, the case in which a proportion of subscriber terminals accessing the wireless relay device (AP) is high among all subscriber terminals within the area with a high concentration of subscribers may be included in the mobile cluster area.

Thereafter, when it is identified that the advertisement provision device 10 is located in the area with a high concentration of subscribers configured as the destination or the stop along the configured moving path according to the control of the movement, the provision unit 12 provides a location-based advertisement (coupon) to subscriber terminals located within the area with a high concentration of subscribers in S23.

At this time, the provision unit 12 may provide the advertisement to the subscriber terminals within the area with a high concentration of subscribers through, for example, a broadcast scheme of broadcasting the advertisement to the area with a high concentration of subscribers or a wireless relay scheme of accessing the wireless relay device (AP) within the area with a high concentration of subscribers and transferring the advertisement to the subscriber terminals accessing the corresponding wireless relay device.

The description of the operation flow in the advertisement provision device 10 according to an embodiment of the present disclosure has been completed, and the operation flow in the service device 20 will be subsequently described.

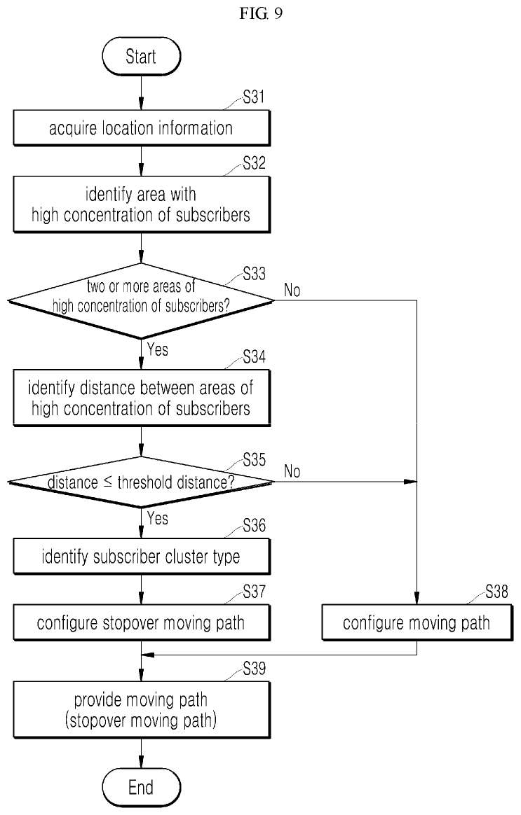

In connection with this, FIG. 9 illustrates the operation flow in the service device 20 according to an embodiment of the present disclosure.

First, the acquisition unit 21 acquires location information through an application from the subscriber terminal in which the corresponding application is installed to receive a service provided by the service device 20 in S31.

At this time, the acquisition unit 21 may acquire location information by receiving location information from the subscriber terminals every configured cycle or requesting and receiving location information from the subscriber terminals every configured cycle.

Meanwhile, when receiving the location information from the subscriber terminals, the acquisition unit 21 may also acquire information on whether the subscriber terminals access the wireless relay device (AP), that is, a Wi-Fi network.

Then, the acquisition unit 22 identifies the area with a high concentration of subscribers based on location information acquired from the subscriber terminal in S32.

At this time, the area with a high concentration of subscribers may be understood as an area in which a predetermined number or more of subscriber terminals is concentrated, and the area with a high concentration of subscribers may be changed by locations of the subscriber terminals according to the time and the situation.

Next, when the area with a high concentration of subscribers is identified based on the location information of the subscriber terminal, the configuration unit 32 configures a moving path in which the area with a high concentration of subscribers is a destination or a stop in S33 and S38.

Meanwhile, when two or more areas with a high concentration of subscribers are identified based on the location information of the subscriber terminal, the configuration unit 23 may configure a stopover moving path to pass through all of the two or more areas with a high concentration of subscribers.

In connection with this, FIG. 5 illustrates the case in which the area A with a high concentration of subscribers, the area B with a high concentration of subscribers, and the area C with a high concentration of subscribers are identified based on location information of subscriber terminals as an example.

In this case, the configuration unit 23 identifies distances d₁, d₂, and d₃ between the area A with a high concentration of subscribers, the area B with a high concentration of subscribers, and the area C with a high concentration of subscribers, and when the identified distances d₁, d₂, and d₃ are shorter than a threshold distance, determines the area A with a high concentration of subscribers, the area B with a high concentration of subscribers, and the area C with a high concentration of subscribers as an advertisement provision group and configures a stopover movement path to pass through all of the areas with a high concentration of subscribers within the advertisement provision group in S35 to S37.

When all of the distances between the area A with a high concentration of subscribers, the area B with a high concentration of subscribers, and the area C with a high concentration of subscribers are longer than the threshold distance, the configuration unit 23 configures individual movement paths of the area A with a high concentration of subscribers, the area B with a high concentration of subscribers, and the area C with a high concentration of subscribers.

The individual movement paths may be understood as different advertisement provision devices for providing an advertisement to the area A with a high concentration of subscribers, the area B with a high concentration of subscribers, and the area C with a high concentration of subscribers.

Meanwhile, the stopover movement path may include a movement priority for determining the movement order of each of the area A with a high concentration of subscribers, the area B with a high concentration of subscribers, and the area C with a high concentration of subscribers based on a subscriber cluster type of each of the area A with a high concentration of subscribers, the area B with a high concentration of subscribers, and the area C with a high concentration of subscribers.

The subscriber cluster type may include a fixed cluster area, having a high proportion of subscriber terminals, of which locations are changed within the threshold distance, among all subscriber terminals within the area with a high concentration of subscribers, and a mobile cluster area, having a high proportion of subscriber terminals, of which locations are changed beyond the threshold distance, among all subscriber terminals within the area with a high concentration of subscribers, wherein the mobile cluster area has a higher movement priority than the fixed cluster area.

As described above, the reason why the higher movement priority is assigned to the mobile cluster area than the fixed cluster area is to take into account the high probability that the cluster is scattered due to the mobile characteristic of subscriber terminals within the area with a high concentration of subscribers. Accordingly, by assigning the high priority to the mobile cluster area, an advertisement can be provided to the corresponding area with a high concentration of subscribers in less time.

Meanwhile, all of the area A with a high concentration of subscribers, the area B with a high concentration of subscribers, and the area C with a high concentration of subscribers may be mobile cluster areas, or conversely, may be fixed cluster areas, in which case the movement priority may be assigned in descending order of the proportion of subscriber terminals of which locations are changed within each area with a high concentration of subscribers.

In addition, the condition for determining the subscriber cluster type may be based on whether the subscriber terminal accesses a wireless relay device (AP), that is, a Wi-Fi network, as well as the change in the location of the subscriber terminal as described above.

In connection with this, the configuration unit 23 may include the case in which a proportion of subscriber terminals accessing the wireless relay device (AP) is high among all subscriber terminals within the area with a high concentration of subscribers in the fixed cluster area or, conversely, the case in which a proportion of subscriber terminals accessing the wireless relay device (AP) is high among all subscriber terminals within the area with a high concentration of subscribers in the mobile cluster area.

For reference, in connection with the configuration of the stopover movement path, when there is an area which does not meet the condition of the area with a high concentration of subscribers but in which some subscriber terminals are concentrated on the moving path between the areas with a high concentration of subscribers within the advertisement provision group, the configuration unit 23 may insert the area into the advertisement provision group as a stopover area and thus provide an advertisement to the stopover area during movement between the areas with a high concentration of subscribers.

Thereafter, when a moving path in the case in which the number of areas with a high concentration of subscribers is one or a stopover moving path in the case in which the number of areas with a high concentration of subscribers is two or more is completely configured, the provision unit 24 provides the configured moving path (stopover moving path) to the advertisement provision device 10 in S39.

In connection with this, the advertisement provision device 10 may be located in the destination or the stop configured as the moving path, that is, in the area with a high concentration of subscribers, by controlling movement of the advertisement provision device 10 along the moving path received from the service device 20, and when it is identified that the advertisement provision device 10 is located in the area with a high concentration of subscribers, provides a location-based advertisement (coupon) to subscriber terminals within the area with a high concentration of subscribers.

At this time, the advertisement provision device 10 may provide the advertisement to the subscriber terminals within the area with a high concentration of subscribers through, for example, a broadcast scheme of broadcasting the advertisement to the area with a high concentration of subscribers or a wireless relay scheme of accessing the wireless relay device (AP) within the area with a high concentration of subscribers and transferring the advertisement to the subscriber terminals accessing the corresponding wireless relay device.

As described above, according to the location-based advertisement provision system and each element within the system according to an embodiment of the present disclosure, it is possible to improve effectiveness of provision of the advertisement by flexibly providing an advertisement suitable for an area with a high concentration of subscribers varying depending on a time and a situation as an area with a high concentration of subscribers in which subscriber terminals are concentrated is configured as a moving path of the advertisement provision device 10 and the advertisement is provided through the advertisement provision device moving along the configured moving path.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

### INDUSTRIAL APPLICABILITY

The present disclosure, pertaining to the subscriber terminal and the method of operating the same, has industrial applicability since the technology is relevant and useful in that the present disclosure overcomes the limit of the prior art, the applied device is sufficient to be brought to market and sold, and it is obvious that the applied device is practicably realized in that the subscriber terminal may configure a moving path of an advertisement provision device in consideration of an area with a high concentration of subscribers in which subscriber terminals are concentrated and an advertisement may be provided to the area with a high concentration of subscribers through the advertisement provision device along the configured moving path.

What is claimed is:

1. A service device comprising:
a processor configured to process calculations related to provision of an advertisement through an advertisement provision device; and
a memory configured to store at least one command executed through the processor,
wherein the at least one command comprises:
an identification command for causing the processor to identify an area with a high concentration of subscribers in which a predetermined number or more of subscriber terminals is concentrated based on location information acquired from subscriber terminals; and
a configuration command for causing the processor to:
configure the area with a high concentration of subscribers as a moving path of the advertisement provision device; and
provide, by the advertisement provision device, an advertisement to subscriber terminals in the area with a high concentration of subscribers while the advertisement provision device moves along the moving path.

2. The service device of claim 1, wherein the configuration command causes the processor to:
configure a stopover moving path to pass through each of the two or more areas with a high concentration of subscribers when there is two or more the areas with a high concentration of subscribers; and
provide an advertisement to each of the two or more areas with a high concentration of subscribers by the advertisement provision device while the advertisement provision device moves along the stopover moving path.

3. The service device of claim 2, wherein the configuration command causes the processor to:
determine the two or more areas with a high concentration of subscribers as an advertisement provision group when distances between the two or more areas with a high concentration of subscribers are shorter than a threshold distance; and
configure the stopover moving path to pass through areas with a high concentration of subscribers within the advertisement provision group.

4. The service device of claim 2, wherein the stopover moving path comprises:
a movement priority for determining a movement order of the advertisement provision device for each of the two or more areas with a high concentration of subscribers based on a subscriber cluster type of each of the two or more areas with a high concentration of subscribers.

5. The service device of claim 4, wherein the subscriber cluster type comprises:
a fixed cluster area, in which there is a high proportion of subscriber terminals of which locations are changed within the threshold distance among all subscriber terminals within the area with a high concentration of subscribers; and
a mobile cluster area, in which there is a high proportion of subscriber terminals of which locations are changed beyond the threshold distance among all subscriber terminals within the area with a high concentration of subscribers,
wherein the mobile cluster area has a higher movement priority than the fixed cluster area.

6. The service device of claim 5, wherein:
the fixed cluster area includes a case in which there is a high proportion of subscriber terminals accessing a wireless relay device (AP) among all subscriber terminals within the area with a high concentration of subscribers, and
the mobile cluster area includes a case in which there is a high proportion of subscriber terminals which do not access the wireless relay device (AP) among all subscriber terminals within the area with a high concentration of subscribers.

7. The service device of claim 1, wherein the advertisement provision device is configured to:
provide an advertisement according to at least one of a broadcasting scheme of broadcasting the advertisement to the area with a high concentration of subscribers and a wireless relay scheme of accessing the wireless relay device (AP) within the area with a high concentration of subscribers; and
transfer the advertisement to the subscriber terminal accessing the wireless relay device.

8. A method of operating a service device, the method comprising:
identifying an area with a high concentration of subscribers in which a predetermined number or more of subscriber terminals is concentrated based on location information acquired from subscriber terminals; and
configuring the area with a high concentration of subscribers as a moving path of the advertisement provision device, thereby allowing the advertisement provision device to provide an advertisement to subscriber terminals in the area with a high concentration of subscribers while the advertisement provision device moves along the moving path.

9. The method of claim 8, wherein configuring the area comprises:
when there is two or more areas with a high concentration of subscribers, configuring a stopover moving path to pass through each of the two or more areas with a high concentration of subscribers; and
providing, by the advertisement provision device, an advertisement to each of the two or more areas with a high concentration of subscribers while the advertisement provision device moves along the stopover moving path.

10. The method of claim 2, wherein configuring the area comprises:
when distances between the two or more areas with a high concentration of subscribers are shorter than a threshold distance, determining the two or more areas with a high concentration of subscribers as an advertisement provision group; and
configuring the stopover moving path to pass through areas with a high concentration of subscribers within the advertisement provision group.

11. The method of claim 9, wherein the stopover moving path comprises:
a movement priority for determining a movement order of the advertisement provision device for each of the two or more areas with a high concentration of subscribers based on a subscriber cluster type of each of the two or more areas with a high concentration of subscribers.

12. The method of claim 11, wherein the subscriber cluster type comprises:
a fixed cluster area, in which there is a high proportion of subscriber terminals of which locations are changed within the threshold distance among all subscriber terminals within the area with a high concentration of subscribers; and
a mobile cluster area, in which there is a high proportion of subscriber terminals of which locations are changed beyond the threshold distance among all subscriber terminals within the area with a high concentration of subscribers, wherein the mobile cluster area has a higher movement priority than the fixed cluster area.
